(19) United States
(12) Patent Application Publication
(10) Pub. No.: US 2026/0131461 A1
(43) Pub. Date: May 14, 2026

(54) Torque Control Circuitry and Torque Control Methods for Articulated Robots

(71) Applicant: ABB Schweiz AG, Baden (CH)

(72) Inventors: Arne Wahrburg, Weiterstadt (DE); Minda Xia, München (DE); Richard Roberts, Gilching (DE); Tomas Groth, Västerås (SE)

(73) Assignee: ABB Schweiz AG, Baden (CH)

(21) Appl. No.: 19/429,765

(22) Filed: Dec. 22, 2025

Related U.S. Application Data
(63) Continuation of application No. PCT/EP2023/067232, filed on Jun. 26, 2023.

(51) Int. Cl. B25J 9/16

(52) U.S. Cl. CPC B25J 9/1633

(57) ABSTRACT

A method includes receiving a signal representing monitored torque and a signal representing a setpoint torque for a joint of a robot; process the monitored torque and the setpoint torque to produce a control signal for controlling a servomotor of the articulated robot to generate the setpoint torque at the at least one joint; and output the control signal to drive circuitry of the servomotor, wherein the torque control circuitry comprises a first feedback path configured to implement a first controller function, wherein the first controller function is configured to amplify gain in the first feedback path to a larger extent in a first frequency range than in a second frequency range, and wherein the first frequency range comprises frequencies associated with the at least one physical effect which occurs at the at least one joint during use of the articulated robot.

### CROSS-REFERENCE TO RELATED APPLICATIONS

The instant application claims priority to International Patent Application No. PCT/EP2023/067232, filed Jun. 26, 2023, which is incorporated herein in its entirety by reference.

### FIELD OF THE DISCLOSURE

The present disclosure generally relates to torque control circuitry and methods for articulated robots.

### BACKGROUND OF THE INVENTION

A lead-through mode to “take the robot by the hand” for teaching positions and/or paths is considered an important feature for collaborative robots, known in the field as “cobots”. A good lead-through experience is characterized by responsiveness, i.e. low interaction forces, enabled by arm torque control. Interaction forces can be lowered by actively controlling torque at the gearbox output side. Arm torque control has been successfully applied in smaller collaborative robots with satisfying lead-through performance. However, simply applying the same concept to larger robots results in unsatisfying lead-through performance as friction levels for larger robots are higher whereas lever arms might not necessarily increase.

### BRIEF SUMMARY OF THE INVENTION

In one aspect, the present disclosure describes torque control circuitry for an articulated robot. The torque control circuitry is configured to receive a signal representing monitored torque at at least one joint of the collaborative robot and a signal representing a setpoint torque for the at least one joint, wherein the setpoint torque has been predetermined to compensate at least partially for at least one physical effect which occurs at the at least one joint during use of the articulated robot; process the monitored torque and the setpoint torque to produce a control signal for controlling a servomotor of the articulated robot to generate the setpoint torque at the at least one joint; and output the control signal to drive circuitry of the servomotor, wherein the torque control circuitry comprises a first feedback path configured to implement a first controller function, wherein the first controller function is configured to amplify gain in the first feedback path to a larger extent in a first frequency range than in a second frequency range, and wherein the first frequency range comprises frequencies associated with the at least one physical effect which occurs at the at least one joint during use of the articulated robot.

In one embodiment, the first controller function may be configured to modify gain in the first feedback path by one or more first factors over a first frequency range and by one or more second factors over a second frequency range, wherein the one or more first factors are larger than the one or more second factors. The one or more first factors may be larger than the one or more second factors. The frequencies in the second frequency range may be higher than those in the first frequency range.

By amplifying gain in the first feedback path to a greater extent in the first frequency range than in the second frequency range, the first controller function is configured to implement loop-shaping for increasing or maximizing gain in the first frequency range while maintaining, reducing or minimizing gain in the second frequency range. The first controller function may be described as a frequency-dependent gain-modification function. The first frequency range may comprise frequencies which are lower than those comprised in the second frequency range. In this way, the first controller function implements a gain for the lower frequencies of the first frequency range which is higher than that applied to the higher frequencies of the second frequency range.

The articulated robot may comprise a collaborative robot. The collaborative robot may have a lead-through programming mode in which a human operator manipulates the robot to define a sequence of operations subsequently to be repeated by the robot when in an operative mode or productive mode. The at least one physical effect which occurs at the at least one joint during use of the articulated robot may comprise the effect of gravity acting on the at least one joint and/or on one or more components attached to the at least one joint. The at least one physical effect may comprise friction effects acting on (or apparent at) the at least one joint during movement of the joint, such as those which occur during lead-through programming of the robot. In some examples, the at least one physical effect may comprise inertial effects acting on the at least one joint and/or on one or more components attached to the at least one joint.

### BRIEF DESCRIPTION OF THE SEVERAL VIEWS OF THE DRAWING(S)

FIG. 1 is a diagram of an articulated robot in accordance with the disclosure.

FIG. 2 is a block diagram of a torque control circuit for the articulated robot of FIG. 1.

FIG. 3 is a block diagram of a torque control circuit for the articulated robot of FIG. 1.

FIG. 4 is block diagram of a torque control circuit for the articulated robot of FIG. 1.

FIG. 5 is a Bode plot representing characteristics of one non-limiting example of one component of the torque control circuit of FIG. 4.

FIG. 6 is a block diagram of a friction compensation circuit for a torque control circuit in accordance with the disclosure.

FIG. 7 is a diagram of a computing system in accordance with the disclosure.

### DETAILED DESCRIPTION OF THE INVENTION

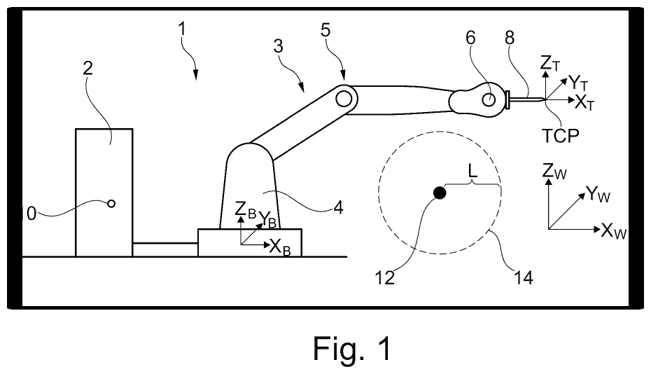

FIG. 1 illustrates an articulated robot 1 in connection with which the torque controller as described and claimed herein may be used. The articulated robot 1 in the non-limiting example shown and described herein is a collaborative robot having a lead-through programming mode. The robot 1 comprises a robot controller 2 and a robotic manipulator 3. The manipulator 3 comprises a plurality of segments that are movable relative to one other about a plurality of joints under the control of the robot controller 2. In this example, the segments comprise a stationary base 4, an arm 5 that is rotatable about the base 4, and a wrist 6 that is rotatable about the arm 5. The wrist 6 supports a tool 8, which is movable in six degrees of freedom. The movements of the joints are driven by servomotors (not shown). The robot controller 2, via its control of the servomotors, controls the positions of the joints, speed of movement, as well as the torque exerted by each servomotor. To that end, alongside the position sensors that are used to provide position feedback to the robot controller 2, the joints are additionally equipped with torque sensors for providing information to the robot controller 2 about the torque generated at the gearbox output side of each servomotor.

In use, the robot 1 is configured to switch between two or more control modes in which the motions of the robot 1 are differently controlled. There is at least one operative mode to be used during normal operation of the robot 1 and at least one programming mode to be used during lead-through programming of the robot 1. Switching between modes may be accomplished using for example a switch 10 provided for that purpose.

During normal operation of the robot 1, motions of the robot 1 are controlled in accordance with a robot control program, and the joints should be stiff to prevent the robot 1 from being moved by pushing or pulling the manipulator 3.

During lead-through programming, the robot 1 is controlled in such a way as to allow the user readily to reposition the manipulator 3 while demonstrating the sequence of operations which the robot 1 is later to reproduce when in the operative mode. The objective in this mode is to provide a higher degree of responsiveness by lowering the interaction forces which are necessary for manually moving the manipulator 3, i.e., so that the manipulator 3 becomes ‘transparent’. The robot controller 2 is therefore configured, when in the lead-through programming mode, to control torque in the robot 1 so that the manipulator 3 exhibits reduced or minimal resistance to movement, preferably in all axes, and in all tool directions and orientations. More particularly, the torque control implemented by the robot controller 2 when in the lead-through programming mode provides compensation for one or more physical effects acting on, or apparent at, one or more joints of the robot 1. This compensatory action of the robot 1 may be designed to compensate not only for the gravitational force acting on the manipulator 3, so that the robot 1 will stay in its current position and orientation when the user releases it, but also for the friction and/or inertia imposed by the components of the manipulator 3.

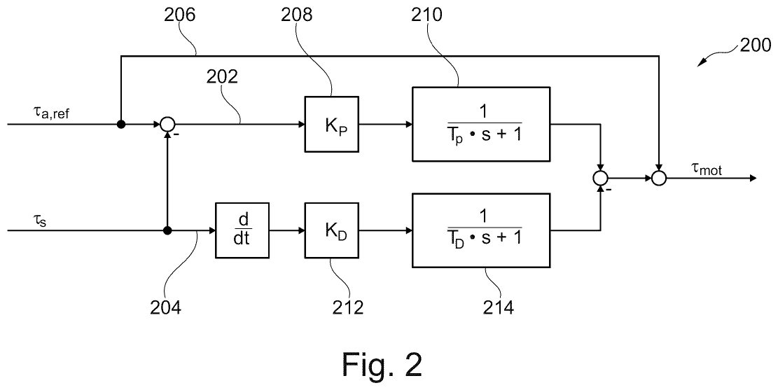

FIG. 2 illustrates one example of torque control circuitry 200 configured to increase compliance during the lead-through programming mode. The torque control circuitry 200 takes the form of a PD controller comprising a proportional path 202 and a derivative path 204. The PD controller 200 furthermore comprises a unity-gain feedforward path 206. The proportional path 202 of the PD controller 200 applies a gain 208 and a low-pass filter 210 to its incoming signal. Similarly, the derivative path 204 applies a gain 212 and a low-pass filter 214 to its incoming signal. The PD controller 200 receives as input the torque Ts monitored at the output side of the gearbox of the respective servomotor, along with a setpoint torque τ_{a,ref}, which has been predetermined to compensate for physical effects at the respective joint. Based on these inputs, the PD controller 200 determines a control signal representing the desired torque τₘₒₜ to be generated by the servomotor. This control signal τₘₒₜ is received by a drive unit (not shown) which outputs an appropriate amount of current to the servomotor.

The objective when operating the PD controller 200 is to increase the gain 208 in the proportional path 202 as much as possible to scale down apparent motor-side friction and/or inertia, resulting in responsive lead-through performance. Considering a simplified single degree of freedom model of a compliant robot joint, it can be shown that the PD controller 200 scales down both effective motor inertia and motor-side friction by a factor

$$\frac{1}{1 + {K}_{p}} .$$

Thus, the larger the proportional gain 208 (i.e., Kₚ), the more the motor-side friction and inertia can be attenuated. Hence, the manipulator 3 becomes easier to move around in the lead-through programming mode. However, increasing the gain 208 in the proportional path 202 may in some implementations require that the derivative gain 212 also be increased to ensure sufficient damping of the closed torque control loop and to prevent e.g. amplification of Harmonic Drive (HD) ripple effects caused by the kinematic error of the gearbox. The derivative gain 212 in turn is limited by the noise level in the torque measurement τ_{S} provided by the respective torque sensor. Higher sensor noise levels result in more high frequency content in the control signal τₘₒₜ output by the PD controller 200, which increases audible high frequency noise in the joint and leads to a more erratic performance in the lead-though programming mode. One common remedy to this problem is to employ more compliant torque sensors to reduce noise torque sensor signals, thereby allowing for higher gains in the proportional and derivative paths, and an improved lead-through experience. However, increasing compliance outside of the lead-through programming mode can be undesirable for motor-side position control, as it reduces achievable path accuracy, output stiffness and disturbance rejection, with strain gauges seeing larger strains and thereby reducing the robustness of the sensors to mechanical overload. It would therefore be desirable to provide arm-side torque control circuitry that enables responsive lead-through performance despite the use of stiff torque sensors.

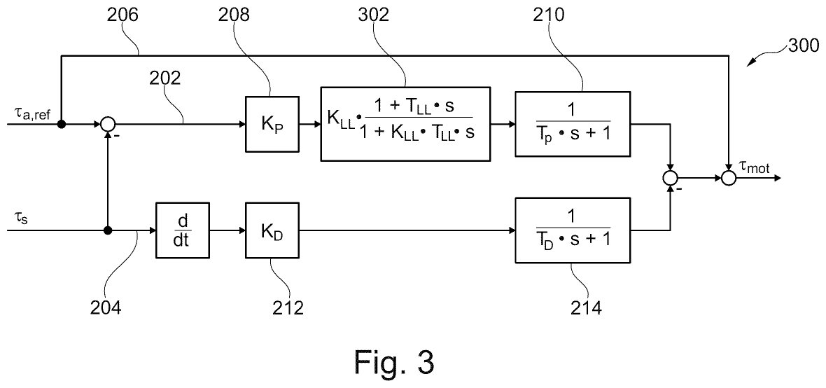

FIG. 3 illustrates another example of torque control circuitry 300 which aims to achieve responsive lead-through performance despite the challenging torque signal quality. The torque control circuitry 300 is based on the torque control circuitry 200 of FIG. 2 and the same reference signs are used to denote the same elements. The torque circuitry 300 of FIG. 3 differs from that of FIG. 2 by the additional of a LAG filter 302 to the proportional path 202 of the PD controller 300. The LAG filter 302 in one non-limiting example has the following transfer function.

$${G}_{P L A G} ( s ) = {K}_{L L} \cdot \frac{1 + \frac{1}{2 π {f}_{L L}} s}{1 + {K}_{L L} \cdot \frac{1}{2 π {f}_{L L}} s}$$

Broadly speaking, the proportional LAG filter 302 is therefore configured to amplify the proportional gain 208 by the factor K_{LL} up to the cutoff frequency f_{LL}. The purpose of the proportional LAG filter 302 is to boost the low frequency gain, based on the recognition that the friction resulting from human interaction with the robot 1 is mostly a low-frequency phenomenon. In one non-limiting example, the cutoff occurs at or around 3 Hz, based on the recognition that the friction arising during human-led lead-through programming does not exhibit frequencies higher than that. In a further non-limiting example, the cutoff occurs at or around 2 Hz. The recognition is based on the observation that friction mainly depends on speed, while speed in the case of lead-through programming results from the human operator moving the robot 1 around, which in turn is typically a low-frequency signal (e.g., <3 Hz, or in other instances <2 Hz). In some examples, the filter cutoff frequencies and gains may be subject to tuning in this regard. Using the LAG filter 302, friction is scaled down further compared to the arrangement of FIG. 2. More particularly, motor-side friction may be scaled down by the factor

$$\frac{1}{1 + {K}_{p} \cdot {K}_{L L}}$$

at lower frequencies, that is, at frequencies below the cutoff f_{LL}. Higher frequency content (above f_{LL}) is scaled down by the factor Kₚ. Roughly speaking, most of the friction is scaled down by Kₚ·K_{LL} (as the friction resulting from human-led motion is mostly a low-frequency phenomenon), while inertia is only scaled down by Kₚ (as inertia is an instantaneous or high-frequency property). Moreover, this scaling may be performed without jeopardizing stability as the proportional gain 208 at high frequencies (where sufficient damping cannot be provided due to the small derivative gain 212) remains low.

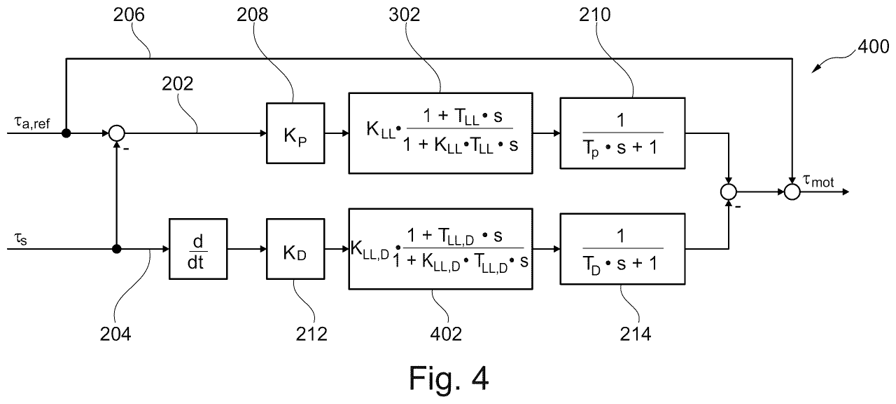

FIG. 4 illustrates a further example of torque control circuitry 400 which represents an improvement over that of FIG. 3. The torque control circuitry 400 differs from that of FIG. 3 by the addition of a separate LAG filter 402 in the derivative path 402 of the PD controller 400. In this non-limiting example, the derivative LAG filter 402 is structurally the same as the proportional LAG filter 302 and is described by the following transfer function.

$${G}_{DLAG} ( s ) = {K}_{LL , D} \cdot \frac{1 + \frac{1}{2 π {f}_{LL , D}} s}{1 + {K}_{LL , D} \cdot \frac{1}{2 π {f}_{LL , D}} s}$$

It will be appreciated, however, that the two LAG filters may be implemented differently than one another. The purpose of the derivative LAG filter 402 is to boost the derivative gain 212 at all but very high frequencies (that is, frequencies at which noise signals are determined to become problematic), recognizing that the limiting factor with respect to increasing the derivative gain 212 is torque sensor noise, which is considered a high frequency effect.

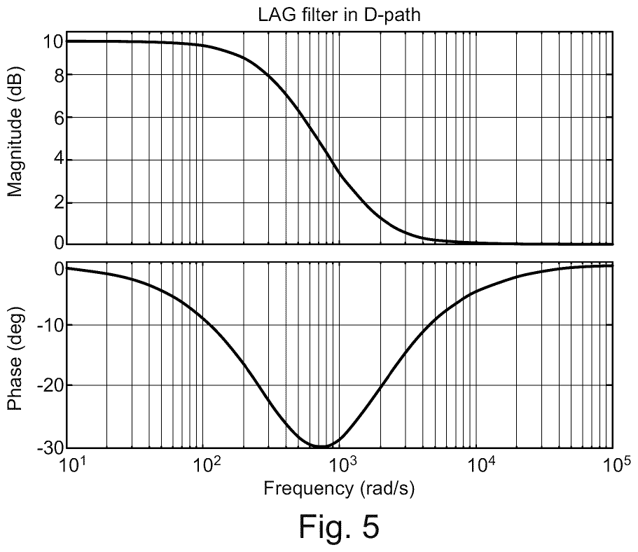

FIG. 5 shows a Bode plot of an example of the derivative LAG filter 402 in which values of the parameters are set at K_{LL,D}=3 and f_{LL,D}=200 Hz. In comparison to the proportional LAG filter 302, the cutoff frequency f_{LL,D} of the derivative LAG filter 402 may be chosen to be notably higher (in one non-limiting example, f_{LL,D}=100 Hz for the main axes (i.e., axes 1, 2, 3 of the robot 1, as is known in the art) and f_{LL,D}=400 Hz for the wrist axes, i.e., axes 4, 5, and 6). This not only allows the proportional LAG filter cutoff frequency to be increased compared to that of FIG. 3 (e.g., to f_{LL}=10 Hz), but also enables an increase to the proportional gain 208 by a factor of 3 on axes 1 and 2, and by a factor of 2 on axes 3 and 4. This increase in the proportional path cutoff frequency may be beneficial in that it allows the proportional path gain to be increased over a larger frequency range, which in turn assists in mitigating friction effects at very low speeds, close to zero, at which there may be some higher frequency components associated with the friction effects. As a result, a notable increase of the effective proportional gain 212 for a large frequency range is achieved.

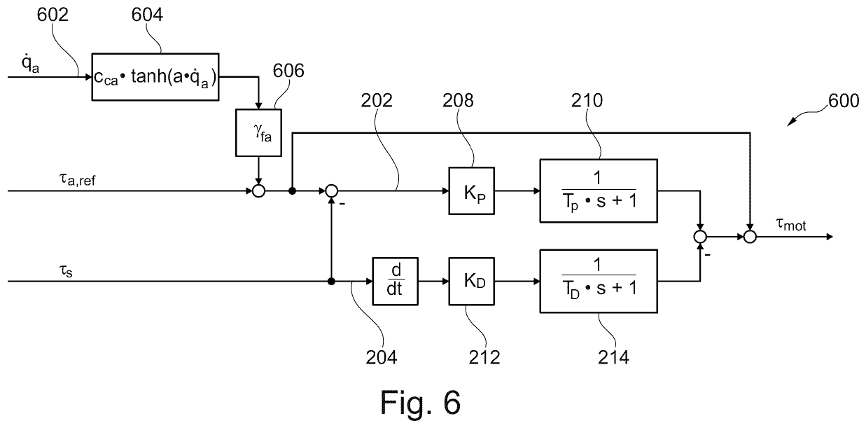

FIG. 6 schematically illustrates a further example of torque control circuitry 600 which is configured to provide output-side friction compensation. The torque control circuitry 600 adds to that of FIG. 2 a friction feedforward path 602.

Inclusion of the feedforward path 602 is based on the recognition that friction compensation measures such as arm torque control and friction observers have the effect that the output-side friction, which would otherwise be small in comparison to the motor-side friction (due to high gear ratios), increases in significance according to the scaling down of the motor-side friction while the output-side friction remains unaltered.

The feedforward path 602 shown in FIG. 6 assumes plain Coulomb friction and uses a tan(h)-approximation of the sign function (a=70). The feedforward path 602 thus serves to scale down output-side friction in an open-loop fashion based on an estimate of output-side friction obtained from a friction model, and maybe therefore be described as model-based friction compensation. During constant speed motion, a notable reduction of interaction torque on axis 6 may be achieved by introducing the output-side friction feedforward path 602.

Numerous variations to the systems and methods described herein may be envisaged. For example, while the robot 1 illustrates in FIG. 1 is a single arm robot, it will be appreciated that the invention is not so limited and may be applied to multi-arm robots such as dual-arm robots.

It will be appreciated that the disclosure is not limited to the use of LAG filters and that other variants are possible which serve to amplify the gain in the respective feedback at selected frequencies while minimizing gain increase at non-selected frequencies, such as loop shaping or H₂ or [symbol] controllers.

In addition to the torque control circuitry described herein, the robot controller 2 may further implement a friction observer to further reduce effective motor-side friction, a speed-dependent adaptive notch filter in the proportional feedback path, and/or arm-inertia scaling in the outer impedance loop to further improve the lead-through experience.

Although the examples described in detail herein concern a collaborative robot having a lead-through programming mode, it will be understood that the torque control circuitry may equally be applied in other forms of robot, such as industrial robots, e.g., those that use gearboxes with integrated torque sensing, and/or those running task-level impedance control or joint-level impedance control.

In further variants, the use of dedicated torque sensors for direct torque sensing may be replaced by the use of model-based torque sensing.

In yet further variants, at least one linear actuator may be used in addition to, or instead of, any of the rotary servomotors described herein. In such variants, references to sensing or controlling torque may be replaced with references to sensing or controlling force. In that sense, references to force may be understood to include torque as a form of force.

In yet other variants, the torque control circuitry as disclosed herein may be used to implement active steering in automotive applications.

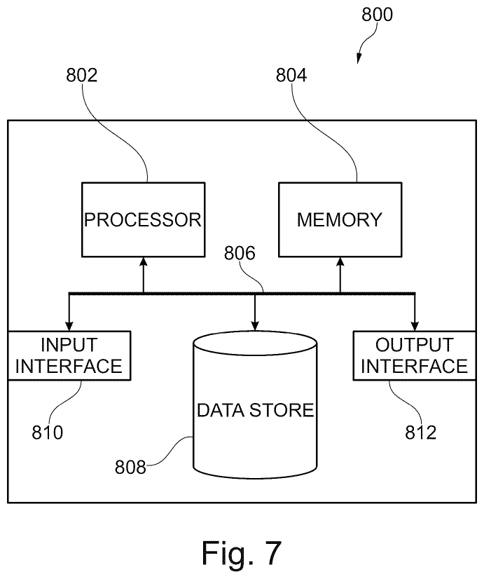

FIG. 7 illustrates an exemplary computing system 800 that can be used in connection with the torque control circuitry and torque control methods disclosed herein. The computing system 800 may form part of or comprise any desktop, laptop, server, or cloud-based computing system. The computing system 800 includes at least one processor 802 that executes instructions that are stored in a memory 804. The instructions may be, for instance, instructions for implementing functionality described as being carried out by one or more components described herein or instructions for implementing one or more of the methods described herein. The processor 802 may access the memory 804 by way of a system bus 806. In addition to storing executable instructions, the memory 804 may also store conversational inputs, scores assigned to the conversational inputs, etc.

The computing system 800 additionally includes a data store 808 that is accessible by the processor 802 by way of the system bus 806. The data store 808 may include executable instructions, log data, etc. The computing system 800 also includes an input interface 810 that allows external devices to communicate with the computing system 800. For instance, the input interface 810 may be used to receive instructions from an external computer device, from a user, etc. The computing system 800 also includes an output interface 812 that interfaces the computing system 800 with one or more external devices. For example, the computing system 800 may display text, images, etc. by way of the output interface 812.

It is contemplated that the external devices that communicate with the computing system 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing system 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing system 800 may be a distributed system. Thus, for instance, several devices may be in communication by way of a network connection and may collectively perform tasks described as being performed by the computing system 800.

Various functions described herein can be implemented in hardware, software, or any combination thereof. If implemented in software, the functions can be stored on or transmitted over as one or more instructions or code on a computer-readable medium. Computer-readable media include computer-readable storage media. Computer-readable storage media can be any available storage media that can be accessed by a computer. By way of example, and not limitation, such computer-readable storage media can comprise FLASH storage media, RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal may be included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

In exemplary embodiments, the lower frequencies in the first frequency range may correspond to those which result from the friction effects that arise during typical human interactions with the collaborative robot during lead-through programming. In particular, the first frequency range may comprise frequencies in the range 0-3 Hz. More particularly, the first frequency range may comprise frequencies in the range 0-2 Hz. The first frequency range thus corresponds to typical friction effects or expected friction effects occurring at the respective joint of the collaborative robot during the usual human interaction that takes place during the lead-through programming.

The torque control circuitry may comprise a PD controller, wherein the PD controller comprises the first feedback path. The PD controller may furthermore comprise a unity-gain feedforward path. In one example, the first feedback path is a proportional feedback path of the PD controller. In this case, the gain which is modified by the first factor over the first frequency range and by the second factor over the second frequency range comprises the proportional path gain of the PD controller. Stated differently, the first controller function which is configured to modify the proportional path gain may be configured to amplify the proportional path gain by one or more factors which are higher for frequencies below a predetermined cutoff frequency than for frequencies above the predetermined cutoff frequency. The controller function may comprise a filter. More particularly, the filter may comprise a LAG filter. The transfer function of the filter may be selected to enable the filter to modify the proportional path gain in the first feedback path by the one or more first factors over the first frequency range and by the one or more second factors over the second frequency range. In one particular example, the transfer function of the filter may be represented by

$${G}_{P L A G} ( s ) = {K}_{L L} \cdot \frac{1 + \frac{1}{2 π {f}_{L L}} s}{1 + {K}_{L L} \cdot \frac{1}{2 π {f}_{L L}} s} .$$

Increasing the proportional path gain at lower frequencies in this way may facilitate reductions in the motor-side friction effects (as well as the apparent motor inertia) which occur at the joint, thus providing for an improved lead-through experience. Moreover, the lower gains effected in the second frequency range may allow the torque control circuitry to avoid or mitigate problems resulting from high-frequency noise.

In a further example, a second feedback path of the torque control circuitry comprises a second controller function configured to amplify gain in the second feedback path to a larger extent in a third frequency range than in a fourth frequency range, wherein the third frequency range comprises configured to provide damping to compensate for the amplified proportional path gain. Stated differently, the second controller function may be configured to modify gain in the second feedback path by one or more third factors over a third frequency range and by one or more fourth factors over a fourth frequency range, wherein the one or more third factors are larger than the one or more fourth factors. The one or more third factors may be larger than the one or more fourth factors. The frequencies in the fourth frequency range may be lower than those in the third frequency range. The second feedback path may comprise a derivative feedback path, in the case that the torque control circuitry comprises a PD controller. The frequencies in the fourth frequency range may be higher than those in the third frequency range. In one particular non-limiting example, the third frequency range comprises frequencies up to and including 200 Hz. In another non-limiting example, the third frequency range comprises frequencies up to and including 100 Hz, where the joint corresponds to a main axis of the collaborate robot. In another non-limiting example, the third frequency range comprises frequencies up to and including 400 Hz, where the joint corresponds to a wrist axis of the collaborative robot. The second controller function may comprise a filter. The filter may comprise a LAG filter. The transfer function of the filter may be selected to enable the filter to modify the derivative path gain in the second feedback path by the one or more third factors over the third frequency range and by the one or more fourth factors over the fourth frequency range. In one particular example, the transfer function of the filter may be represented by

$${G}_{D L A G} ( s ) = {K}_{LL , D} \cdot \frac{1 + \frac{1}{2 π {f}_{LL , D}} s}{1 + {K}_{LL , D} \cdot \frac{1}{2 π {f}_{LL , D}} s}$$

In this way, the second controller function increases the derivative path gain for low to medium frequencies (that is, frequencies up to and including the cutoff created by the second controller function) and thereby allows an increased gain in the proportional path as well as a higher cutoff frequency between the first and second frequency ranges. In particular, the second controller function ensures sufficient damping and/or stability margin (i.e., derivative path gain) for low to medium frequencies, which allows higher proportional path gains to be achieved at low frequencies. Generally, it is desirable for the proportional path gain to be as large as possible because this scales down both apparent inertia and friction. When raising the proportional path gain, the derivative path gain may be increased accordingly to ensure stability. Without the second controller function as described herein, the derivative path gain is limited by the amplification of torque sensor noise (taking the derivative of a noisy signal exacerbates the noise problem). The present disclosure recognizes that torque sensor noise only becomes a problem above certain frequencies (e.g., >100 Hz, >200 Hz, >400 Hz, as described herein). The second controller function serves to raise the derivative path gain at all frequencies except for the range in which torque sensor noise is known to become problematic (one or more such ranges may be predetermined in advance). With the second controller function in place, the proportional path gain can be increased (not only at low frequencies, as in the case that only the first controller function is present). Thereby, a reduction of both apparent inertia and friction is achieved (with the inertia compensation being greater than that in the case in which only the first controller function is present). The inertia reduction becomes more important for larger robots (with bigger motors and/or higher gear ratios). As the second controller function provides additional damping over a large frequency range, it is possible not only to increase the proportional path gain but also to increase the cutoff frequency of the first controller function (i.e., raise the proportional path gain over a broader frequency range than is possible without the second controller function).

Additionally, or alternatively to the first and/or second controller functions described herein, the torque control circuitry may further comprise a feedforward function configured to provide output-side friction compensation. The feedforward function receives as input signal an actual (i.e., measured) output-side speed, \dot{q}ₐ. The output-side speed may be obtained in one example by numerical differentiation, optionally with low-pass filtering, of the output-side position measurement. The feedforward function generates as output signal a friction compensation torque. The feedforward function processes the input signal to generate the output signal based on a friction model. In one particular example, the friction model is a pure Coulomb friction model (i.e., friction=constant*sign (speed)) but any other friction model could be used. To circumvent numerical issues/bang-bang behavior around zero speed (standstill), the friction model may use a continuous approximation of the sign function, such as the tanh function. To account for possible inaccuracies in the friction model, the model output may be scaled, for example by a factor, 0<γ_{fa}<1, before being applied as a feedforward term. In this way, recognizing that arm torque control scales down only the motor-side friction, such that (e.g., for the wrist axes) friction on the output side of the gearbox can become the dominating factor, the output-side friction feedforward reduces the apparent output-side friction.

The torque control circuitry as described and claimed herein may be referred to as arm-side torque control circuitry.

The torque monitored at the at least one joint of the collaborative robot may comprise a measured torque and/or an estimated torque. In one non-limiting example, a torque sensor such as a dedicated strain-gauge-based torque sensor may be positioned in each joint to measure torque. Additionally or alternatively, joint torque can be estimated (i.e. measured “indirectly”), for example by measuring the position of two encoders (one on the gearbox input- and one on the gearbox output-side) and inferring torque based on the deflection between the encoders and a stiffness/compliance model of the gearbox (mapping deflection to an estimate of torque).

The torque monitored at least one joint of the collaborative robot may comprise the torque monitored at the motor-output side of the at least one joint.

The torque control circuitry may further comprise one or more low-pass filters in one or more of the feedback paths. The one or more low-pass filters may serve to reduce high-frequency noise further.

The torque control circuitry may further comprise one or more notch filters in the proportional path configured to reduce proportional path gain at one or more frequencies that are predetermined to be associated with motor harmonics or harmonic drive ripple effects caused by the kinematic error of the servomotor gearbox. The one or more notch filters may comprise one or more speed-dependent adaptive notch filters.

The robot controller may be further configured to implement arm-inertia scaling in an outer impedance loop to further improve the lead-through experience.

In addition to the torque control circuitry described herein, the robot controller may further comprise one or more friction observers to further reduce effective motor-side friction.

According to a second aspect, there is provided a torque control method for an articulated robot. The torque control method comprises: receiving a signal representing monitored torque at at least one joint of the articulated robot and a signal representing a setpoint torque for the at least one joint, wherein the setpoint torque has been predetermined to compensate at least partially for at least one physical effect which occurs at the at least one joint during use of the articulated robot; processing the monitored torque and the setpoint torque to produce a control signal for controlling a servomotor of the articulated robot to generate the setpoint torque at the at least one joint; and outputting the control signal to drive circuitry of the servomotor, wherein the torque control circuitry comprises a first feedback path configured to implement a first controller function, wherein the first controller function is configured to amplify gain in the first feedback path to a larger extent in a first frequency range than in a second frequency range, and wherein the first frequency range comprises frequencies associated with the at least one physical effect which occurs at the at least one joint during use of the articulated robot.

The method of the second aspect may be computer implemented. According to a third aspect, there is provided a computing system configured to perform the method of the second aspect. According to a fourth aspect, there is provided a computer program (product) comprising instructions which, when executed by a computing system, enable or cause the computing system to perform the method of the second aspect. According to a fifth aspect, there is provided a computer-readable (storage) medium comprising instructions which, when executed by a computing system, enable or cause the computing system to perform the method of the second aspect. The computer-readable medium may be transitory or non-transitory, volatile or non-volatile.

The term “circuitry”, as used herein, may comprise, for example, singly or in any combination, hardwired circuitry, programmable circuitry such as computer processors comprising one or more individual instruction processing cores, state machine circuitry, and/or firmware that stores instructions executed by programmable circuitry. Modules may, collectively or individually, be embodied as circuitry that forms a part of one or more devices or systems as described herein. The term “circuitry” may be used interchangeably herein with equivalent terms such as “module”, “system”, “engine”, “tool”, and so on”.

The term “obtaining”, as used herein, may comprise, for example, receiving from another system, device, or process; receiving via an interaction with a user; loading or retrieving from storage or memory; measuring or capturing using sensors or other data acquisition devices.

The term “determining”, as used herein, encompasses a wide variety of actions, and may comprise, for example, calculating, computing, processing, deriving, investigating, looking up (e.g., looking up in a table, a database or another data structure), ascertaining, and the like. Also, “determining” may comprise receiving (e.g., receiving information), accessing (e.g., accessing data in a memory), and the like. Also, “determining” may comprise resolving, selecting, choosing, establishing and the like.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A torque control circuitry for an articulated robot, the torque control circuitry being configured to:
receive a signal representing monitored torque at at least one joint of the articulated robot and a signal representing a setpoint torque for the at least one joint, wherein the setpoint torque has been predetermined to compensate at least partially for at least one physical effect which occurs at the at least one joint during use of the articulated robot;
process the monitored torque and the setpoint torque to produce a control signal for controlling a servomotor of the articulated robot to generate the setpoint torque at the at least one joint; and
output the control signal to drive circuitry of the servomotor, wherein the torque control circuitry comprises a first feedback path configured to implement a first controller function, wherein the first controller function is configured to amplify gain in the first feedback path to a larger extent in a first frequency range than in a second frequency range, and wherein the first frequency range comprises frequencies associated with the at least one physical effect which occurs at the at least one joint during use of the articulated robot.

2. The torque control circuitry of claim 1, wherein the torque control circuitry comprises a proportional/derivative (PD) controller, wherein the first feedback path comprises a proportional feedback path of the PD controller, and wherein the gain in the first feedback path which is amplified by the first controller function comprises the proportional path gain of the PD controller.

3. The torque control circuitry of claim 2, further comprising a LAG filter configured to implement the first controller function.

4. The torque control circuitry of claim 3, wherein the LAG filter is configured to implement a transfer function represented by G_PLAG (s)=K_LL·(1+1/(2πf_LL) s)/(1+K_LL·1/(2πf_LL) s).

5. The torque control circuitry of claim 1, wherein a second feedback path of the torque control circuitry comprises a second controller function configured to amplify gain in the second feedback path to a larger extent in a third frequency range than in a fourth frequency range, wherein the third frequency range comprises configured to provide damping to compensate for the amplified proportional path gain.

6. The torque control circuitry of claim 5, wherein the torque control circuitry comprises a PD controller, wherein the second feedback path comprises a derivative feedback path of the PD controller, and wherein the gain in the second feedback path which is amplified by the second controller function comprises the derivative path gain of the PD controller.

7. The torque control circuitry of claim 5, further comprising a LAG filter configured to implement the second controller function.

8. The torque control circuitry of claim 7, wherein the LAG filter is configured to implement a transfer function represented by G_DLAG (s)=K_(LL,D)·(1+1/(2πf_(LL,D)) s)/(1+K_(LL,D)·1/(2πf_(LL,D)) s).

9. The torque control circuitry of claim 1, further comprising a feedforward function configured to provide output-side friction compensation.

10. The torque control circuitry of claim 9, wherein the feedforward function is configured to receive, as an input signal, a measured output-side speed, and to generate, based on a friction model, a friction compensation torque as an output signal.

11. A torque control method for an articulated robot, the torque control method comprising:
receiving a signal representing monitored torque at at least one joint of the articulated robot and a signal representing a setpoint torque for the at least one joint, wherein the setpoint torque has been predetermined to compensate at least partially for at least one physical effect which occurs at the at least one joint during use of the articulated robot;
processing the monitored torque and the setpoint torque to produce a control signal for controlling a servomotor of the articulated robot to generate the setpoint torque at the at least one joint; and
outputting the control signal to drive circuitry of the servomotor, wherein the torque control circuitry comprises a first feedback path configured to implement a first controller function, wherein the first controller function is configured to amplify gain in the first feedback path to a larger extent in a first frequency range than in a second frequency range, and wherein the first frequency range comprises frequencies associated with the at least one physical effect which occurs at the at least one joint during use of the articulated robot.

12. A computer program product comprising instructions which, when executed by a computing system, cause the computing system to perform a torque control method for an articulated robot, the torque control method comprising:
instructions for receiving a signal representing monitored torque at at least one joint of the articulated robot and a signal representing a setpoint torque for the at least one joint, wherein the setpoint torque has been predetermined to compensate at least partially for at least one physical effect which occurs at the at least one joint during use of the articulated robot;
instructions for processing the monitored torque and the setpoint torque to produce a control signal for controlling a servomotor of the articulated robot to generate the setpoint torque at the at least one joint; and
instructions for outputting the control signal to drive circuitry of the servomotor, wherein the torque control circuitry comprises a first feedback path configured to implement a first controller function, wherein the first controller function is configured to amplify gain in the first feedback path to a larger extent in a first frequency range than in a second frequency range, and wherein the first frequency range comprises frequencies associated with the at least one physical effect which occurs at the at least one joint during use of the articulated robot.
